(19) United States
(12) Patent Application Publication
(10) Pub. No.: US 2014/0259131 A1
(43) Pub. Date: Sep. 11, 2014

(54) METHOD FOR CREATING A SECURITY CERTIFICATE

(71) Applicant: GO DADDY OPERATING COMPANY, LLC, Scottsdale, AZ (US)

(72) Inventors: Leanne N. Gough, Chandler, AZ (US); David Wootan, Scottsdale, AZ (US); Wayne Thayer, Phoenix, AZ (US)

(73) Assignee: Go Daddy Operating Company, LLC, Scottsdale, AZ (US)

(21) Appl. No.: 13/787,174

(22) Filed: Mar. 6, 2013

(51) Int. Cl. H04L 29/06

(52) U.S. Cl. CPC H04L 63/0823
USPC 726/6; 726/10

(57) ABSTRACT

A system and method for creating a security certificate is presented. A request for a security certificate is received from a requester. The request includes an identification of a web site or an entity associated with the web site. An applicant for the security certificate is identified using the request, and information about the applicant for the security certificate is retrieved. The information about the applicant includes a name of the applicant. The information about the applicant is analyzed to determine whether the information about the applicant includes personal information of an individual. When the information about the applicant includes personal information of an individual, the security certificate is generated, wherein the security certificate does not include the personal information of an individual.

### CROSS-REFERENCE TO RELATED APPLICATIONS

This application is related to U.S. patent application Ser. No. ______, filed on ______, and entitled “SYSTEM FOR CREATING A SECURITY CERTIFICATE.”

### BACKGROUND OF THE INVENTION

The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., web server or web site) to send graphical web pages of information to a remote client computer system. The remote client computer system can then display the web pages. Each resource (e.g., computer or web page) of the WWW is uniquely identifiable by a Uniform Resource Locator (“URL”). To view a specific Web page, a client computer system specifies the URL for the web page in a request (e.g., a HyperText Transfer Protocol (“HTTP”) request). These follow the familiar format http://www.xxx.com uniquely identifying the particular resource. The request is forwarded to the web server that supports that web page to the client computer system. When the client computer system receives the web page, the client computer system typically displays the web page using a browser. A browser is a special-purpose application program that effects the requesting of web pages and the displaying of web pages.

Generally a web page's address or URL is made up of the name of the server along with the path to the file or the server. Rather than using a web hosting service's server name as their URL, most companies and many individuals and other entities prefer a “domain name” of their own choosing. In other words, the Ford Motor Company probably would prefer http://www.ford.com as its URL rather than, say, http://servername.com/.about.ford, where “servername” is the name of a Web hosting service whose server The Ford Motor Company uses. For this purpose then a “domain name,” e.g. “ford” can be registered, if available, and the hosting service will use that URL for its customer's web address.

As is well known, the Internet, in conjunction with the WWW is used every day to execute a large number of transactions, many of which can be of a sensitive or confidential nature. Monetary transactions, for example, often involve the communication of sensitive financial data that should not be divulged to third parties. Other transactions may involve trade secrets, personal information, and the like, that should not be publicly available. When sensitive information is communicated via the Internet, in certain circumstances, it is sometimes possible for malicious third parties to access that information. Two common schemes for accessing such information involve 1) the malicious user creating a web site that imitates the identity of another, trusted, entity, and 2) a man-in-the-middle attack, where the malicious user intercepts the sensitive communication.

The first type of fraud involves the malicious operator of a web site hiding or obscuring their identity from their customers. Essentially, the operator of a web site takes advantage of the anonymity provided by the Internet, thereby making it difficult for customers to locate and punish a fraudulent web site operator. For example, a web site may purport to be from a known and trusted business when the web site is in fact operated by an unscrupulous individual. The malicious user may try to receive credit card numbers or pass off goods and services under another's trademark as part of their fraudulent scheme.

To increase the perceived validity of the malicious user's false web site, the malicious user may have inserted false information in the WHOIS database when registering their false domain name in order to hide their identity.

The second type of fraud involves malicious individuals intercepting confidential information, such as credit card numbers, transmitted over the Internet between a customer and a legitimate web site. This type of fraud is less common and can be prevented by transmitting confidential information only in a sufficiently strong encrypted format.

A common method for Internet businesses to protect their customers from these two types of fraud is to obtain a secure certificate, such as a Secure Sockets Layer (SSL) certificate, for their web sites. A secure certificate, once installed on a web site, lets customers know that the owner of the web site (that is, the holder of the certificate) has been verified by a trusted third party (e.g., a certificate authority or CA) and that confidential communications with the web site are or, at least, can be encrypted. SSL is a protocol for transmitting private documents via the Internet. SSL protects confidential information by using a private key to encrypt data transferred over an SSL connection. Many, many applications support the SSL protocol, and many web sites use the protocol to communicate confidential information with their customers.

When connecting to a web site using the SSL protocol, the customer's browser accesses the web site's security certificate and retrieves information regarding the certificate authority that issued the web site's security certificate. The browser may then decide whether or not to trust the web site's security certificate based on which certificate authority issued the web site's security certificate, as well as other information contained within the security certificate.

In addition to a number of cryptographic codes (i.e., public keys) used to implement encrypted communications, security certificates, such as SSL certificates, include information describing the entity to which the certificate was issued. This information can be accessed by a user (e.g., a shopper planning to purchase an item from an online store) in order to learn additional information regarding the certificate holder and further validate that entity's identification before entering into a transaction. Table 1, below, shows a listing of example contents of one type of security certificate.

TABLE 1

| Field | Description |
|---|---|
| Serial Number | An identifier for the certificate |
| Subject | The entity associated with the certificate |
| Signature Algorithm | The algorithm used to create the |
| | signature for the certificate |
| Signature Hash Algorithm | The algorithm used to create a hash of |
| | the public key contained within the |
| | certificate |
| Issuer | The entity that issued the certificate |
| Valid From | The date upon which the certificate |
| | becomes valid |
| Valid To | The date upon which the certificate |
| | expires |
| Public Key | The public key utilized for secure |
| | communications |

To assist users in inspecting a particular security certificate, many applications, such as web browsers, include programs having user interfaces by which the user can open the contents of a certificate and inspect those contents. FIG. 1 is an illustration of a user interface for browsing the contents of an SSL certificate showing example data. The interface includes first display area 2 and second display area 4. Display area 2 provides a listing of the different fields of information that are present within the selected security certificate. Display area 2 also provides a view of a preliminary portion of the data associated with each field. Once a field has been selected by the user, the full contents of the selected field are display in display area 2. In the example shown in FIG. 1, the user has selected the “Subject” field in display area 2, causing the full contents of the Subject field to be display in display area 4. As illustrated, the Subject field identifies a web site associated with the certificate, as well as personal information (name, city, state, country) of an individual to whom the certificate has been issued.

Each field of an SSL certificate may include multiple pieces of information. The subject field, specifically, can include a listing of personal details relating to the holder of the certificate, which may be an individual, a business, or a particular device. For example, the subject field can include a common name (CN), often the holder's domain name, an organization name (O), usually a company or individual's name, a locality (L), such as a city, a state (S), and a country (C) (see the example of FIG. 1). In some cases, the subject field may also identify a serial number associated with the certificate (SERIALNUMBER).

When a security certificate is held by an individual, the subject field includes a listing of that individual's personal information, such as name, cite, state and country. When a certificate is issued to a company, the subject field of the certificate includes information about the company.

Before a formal SSL certificate can be issued, a certificate authority is required to sign off on the identity of the holder of the certificate. As such, the certificate authority is required to confirm that the individual or business listed in the subject field of the certificate actually exists and is accurately described within the certificate. Unfortunately, there are some circumstances in which it can be difficult to verify the existence and identity of a company. For example, a company may be going through the process of requesting a security certificate before that company has been formally organized. In that case, it will be impossible to verify the existence of the company as no formal registration of the company exists. Similarly, in foreign countries (e.g., countries that are foreign to a hosting provider hosting the web site or the responsible certificate authority) it may be difficult for a particular certificate authority to access corporate documents in order to verify that a particular company exists.

In those circumstances, rather than require that the company's existence and identity be validated before issuing the security certificate, the certificate can sometimes be issued in the name of one of the principals of the company. Because the identity of the principal can be readily confirmed, and because the principal is closely associated with the company (or the company that will be formed in the future), the principal can be viewed as a trustworthy entity to whom the certificate can be issued. When the certificate is issued to a principal, the certificate is constructed in the same manner as one issued to an individual. As a result, the personal identifying information for that principal is listed in the subject information of the certificate.

When a certificate is issued to an individual, in many cases it would be desirable if the personal contact information of the individual were not incorporated into the certificate and, thereby, made publicly available.

### BRIEF DESCRIPTION OF THE DRAWINGS

FIG. 1 is an illustration of a user interface for browsing the contents of an SSL certificate showing example data.

FIG. 2 is a block diagram illustrating an example system for issuing security certificates.

FIG. 3 is a flowchart illustrating a method for providing a security certificate in which the personal information of an individual associated with the certificate may be obscured or hidden.

FIG. 4 is a block diagram showing additional functional blocks of a system, such as the hosting provider of FIG. 1, configured to perform the method illustrated in FIG. 3.

FIG. 5 is an illustration of an exemplary user interface of a program configured to inspect the contents of a security certificate created in accordance with the present disclosure.

### DETAILED DESCRIPTION OF THE PREFERRED EMBODIMENT

The present invention overcomes the aforementioned drawbacks by providing a system and method for the creation of a security certificate having obscured or hidden personal information of an individual or individual associated with an entity to whom the certificate is issued.

In accordance with one aspect of the invention, the present invention is a method of creating a security certificate includes receiving, from a requester, a request for a security certificate. The request includes an identification of a web site or an entity associated with the web site. The method includes identifying an applicant for the security certificate using the request, and retrieving information about the applicant for the security certificate. The information about the applicant includes a name of the applicant. The method includes analyzing the information about the applicant to determine whether the information about the applicant includes personal information of an individual, and, when the information about the applicant includes personal information of an individual, generating the security certificate, wherein the security certificate does not include the personal information of an individual.

In another implementation, the present invention is a method of requesting a security certificate includes transmitting a request for a security certificate to a server computer. The request includes an identification of a web site or an entity associated with the web site. The request is associated with an applicant for the security certificate. The applicant is an individual. The method includes indicating, to the server computer, that the security certificate is not to include personal information of an individual, and receiving, from the server computer, a security certificate, wherein the security certificate does not include the personal information of the individual.

In another implementation, the present invention is a security certificate prepared by the steps of receiving, from a requester, a request for a security certificate. The request includes an identification of a web site or an entity associated with the web site. The steps include retrieving information about an applicant for the security certificate, analyzing the information about the applicant to determine whether the information about the applicant includes personal information of an individual, and, when the information about the applicant includes personal information of an individual, generating a security certificate, wherein the security certificate does not include the personal information of an individual.

In another implementation, the present invention is a system for creating a security certificate. The system includes a server computer configured to receive, from a requester, a request for a security certificate. The request includes an identification of a web site or an entity associated with the web site. The server computer is configured to identify an applicant for the security certificate using the request, and retrieve information about the applicant for the security certificate. The information about the applicant includes a name of the applicant. The server computer is configured to analyze the information about the applicant to determine whether the information about the applicant includes personal information of an individual, and, when the information about the applicant includes personal information of an individual, generate the security certificate, wherein the security certificate does not include the personal information of an individual.

In another implementation, the present invention is a system for requesting a security certificate comprising a computer configured to transmit a request for a security certificate to a server computer. The request includes an identification of a web site or an entity associated with the web site. The request is associated with an applicant for the security certificate. The applicant is an individual. The computer is configured to indicate, to the server computer, that the security certificate is not to include personal information of an individual, and receive, from the server computer, a security certificate, wherein the security certificate does not include the personal information of the individual.

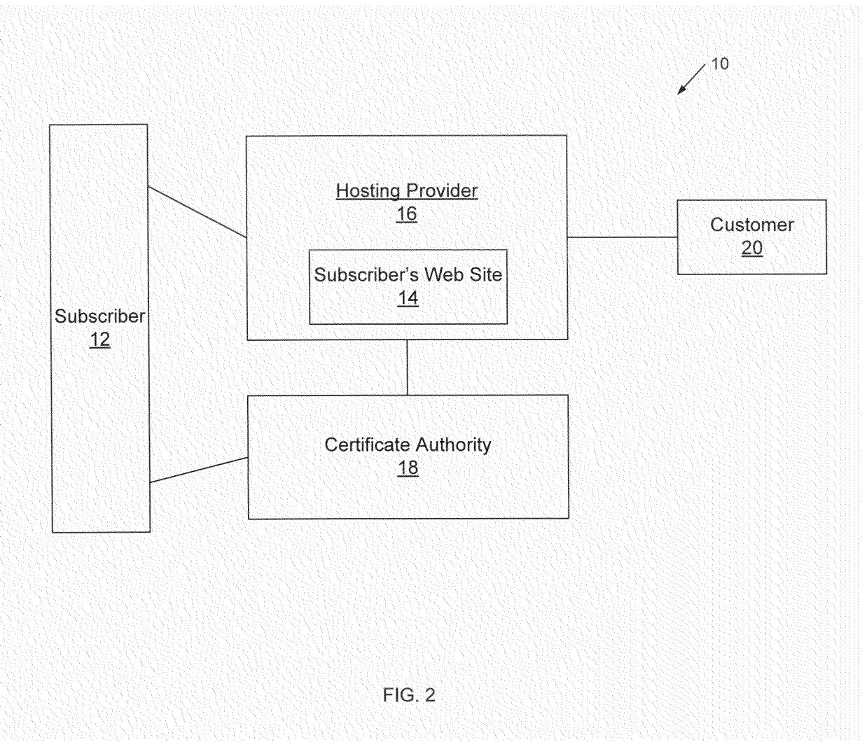

FIG. 2 is a block diagram illustrating an example system 10 for issuing security certificates. Subscriber 10 may be the owner or agent for a web site 14 hosted by hosting provider 16. Hosting provider 16 implements the hardware and software necessary to make subscriber's web site 14 accessible to users on the Internet.

To enable communications through subscriber's web site 14 to be secured, subscriber 12 may request secure communication services (e.g., SSL services) for the web site 14 from hosting provider 16. In one case, this request may be submitted through an appropriate web-based interface provided by hosting provider 16 using a computer accessible to subscriber 12 (e.g., the subscriber's computer). These secure communication services, once implemented, provide assurances to the customers of subscriber 12 (or the other user's of the web site 14 of subscriber 12) that the identity of subscriber 12 has been verified and that web site 14 of subscriber 12 is configured to provide encrypted communications.

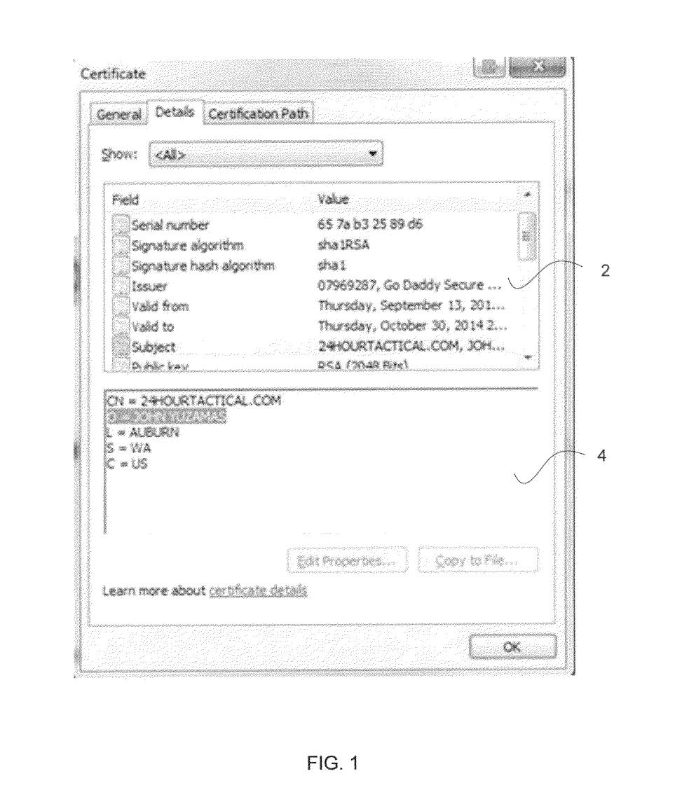

In order to provide secure communication services, a security certificate should first be generated for web site 14. The certificate may include a key pair, including a private key (maintained in secrecy) and a public key (made publicly available on web site 14). With reference to FIG. 1, therefore, subscriber 12, hosting provider 14, or another entity associated with web site 14 may generate the key pair for web site 14. The public and private keys, as is known in the art, are utilized to encrypt communications between customer 20 (and other users) and subscriber's web site 14 and form part of the security certificate.

Even after public and private keys have been generated for web site 14, though, the keys cannot be used to verify identity. Within most encryption regimes, it is possible for any entity to generate their own security keys having any desired content. As a result, a key pair, without more, cannot safely be used to verify the identity of any particular entity.

If a particular security certificate is to be used to verify the identity of an entity, that certificate should be signed by a certificate authority, or other trusted third party. The signature of the certificate authority indicates that the certificate authority has undertaken an independent investigation to determine that the entity to which a particular security certificate claims to have been issued is actually the holder of the certificate. If so, the certificate authority signs the security certificate.

As such, once the public and private keys have been created for web site 14, those keys should be signed by a certificate authority. Accordingly, a certificate signing request (CSR) is generated and transmitted to certificate authority 18. The CSR represents a formal request that certificate authority 18 certify the identity of the certificate holder and, if that identity is certified, sign the public key included in the CSR. The CSR includes information describing the key pair as well as information describing the entity to whom the security certificate will be issued (i.e., the requester). Table 2, below, shows example contents of a CSR.

TABLE 2

| Field | Description |
|---|---|
| Distinguished Name (DN) | The domain name being secured |
| Subject | The entity (either business or individual) |
| | associated with the certificate |
| Departmental Name/ | A department of the Subject that may be |
| Organizational Unit | associated with the certificate |
| Town/City | Location of the Subject |
| Province, Region, County, | Location of the Subject |
| or State | |
| Country | Country of the Subject |
| Email Address | Email address for the Subject |

Upon receipt of the CSR, certificate authority 18 attempts to verify the identity of the requester by, for example, asking for copies of identification documents or by asking for information not publicly available regarding the requester. If the identity of the requester was successfully verified, the certificate authority 18 creates and signs the certificate, which is then transmitted to subscriber 12. Subscriber 12 can then install the signed security certificate on web site 14 (or request hosting provider 16 to do the same). The subscriber's web site 14 is then SSL complaint and may be accessed by customer 20 desiring the extra security provided by the SSL protocol.

Once the SSL certificate is installed, a third party, such as customer 20 desiring to purchase goods and services from subscriber 12, may use a browser to access the subscriber's SSL-compliant web site 14. Several steps are then automatically performed by the browser without any interaction by customer 20 and, in fact, customer 20 may not even know the browser is performing these steps. The browser will request from the web site 14 the web site's signed SSL certificate, which includes the identity of the certificate authority that issued the certificate. Browsers that support the SSL protocol have a list of trusted certificate authorities and the browser will compare the certificate authority that issued the certificate to the list of trusted certificate authorities. This procedure allows the customer's browser to both inspect and verify the identity of the holder of the certificate and ensure that the holder's identity has been validated by a trusted source.

Although in FIG. 2 both hosting provider 16 and certificate authority 18 are shown as separate entities, it should be appreciated that the functions provided by both hosting provider 16 and certificate authority 18 as described herein may be performed or executed by any number of entities. As such, a single entity may perform the functions of both hosting provider 16 and certificate authority 18. Alternatively, the functions of both hosting provider 16 and certificate authority 18 may be further broken down and distributed amongst a larger number of separate entities, such as server computers.

In many cases, security certificates are created on behalf of companies, governmental agencies, community groups, or other entities. As such, the issued certificate will include identifying information for those entities. The identifying information stored in the certificate can then be inspected by a customer or user to ensure that the customer is interacting with the correct entity. When the certificate is issued to an individual, the individual's personal information is included in the certificate, allowing for that individual's identity to be verified. Similarly, when a certificate is issued to a company, but it is difficult to verify the identity of the company (e.g., because the company has not been formally registered or the company is located in another country), the certificate may include personal information or one or more of the principals of the company. When a certificate is issued to an individual or principal, in many cases it would be desirable if the personal information of the principal or individual were not incorporated into the certificate and, thereby, made publicly available.

As such, the present system and method provides for the creation of a security certificate in which personal information of an individual may be obscured or hidden, while still enabling a certificate authority to validate the individual's identify and sign the certificate.

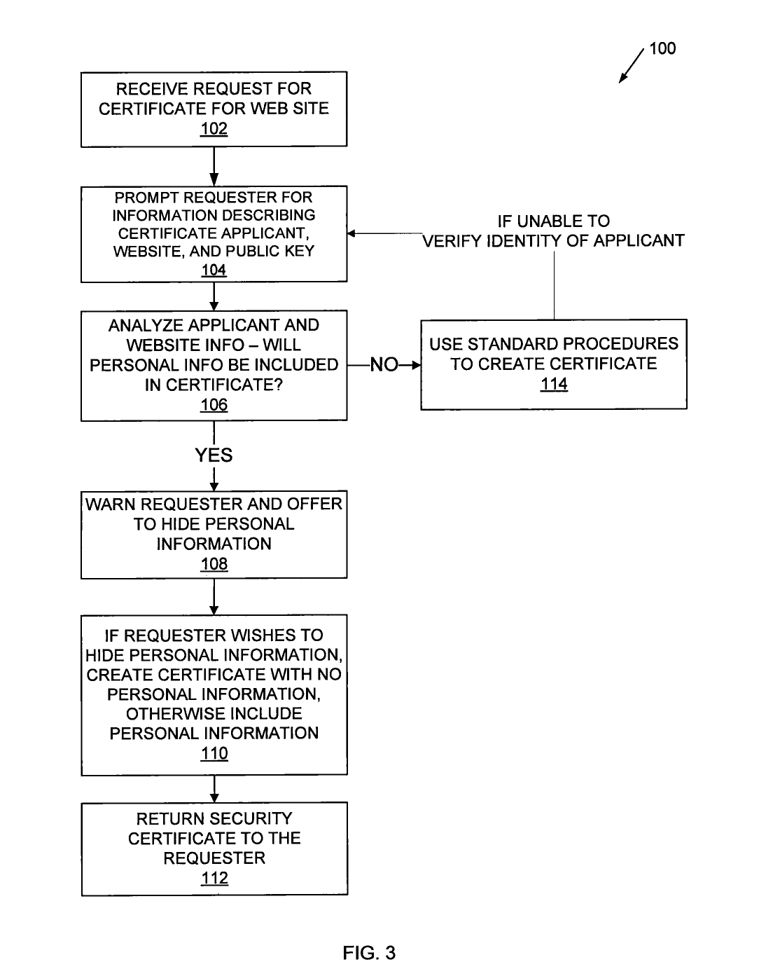

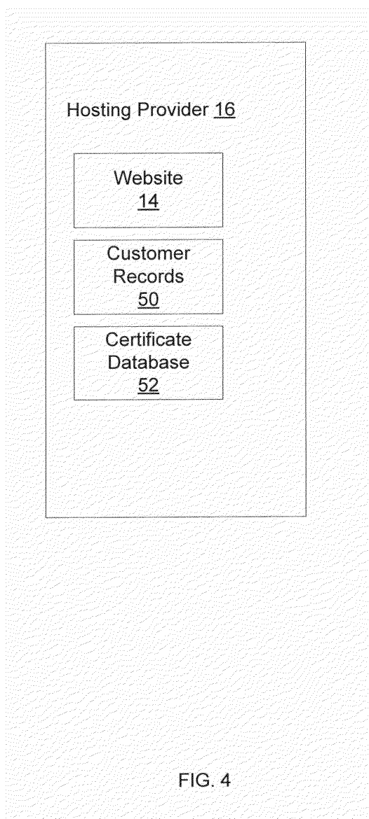

FIG. 3 is a flowchart illustrating a method for providing a security certificate in which the personal information of an individual associated with the certificate may be obscured or hidden. FIG. 4 is a block diagram showing additional functional blocks of a system, such as the hosting provider 16 of FIG. 1, configured to perform the method illustrated in FIG. 3. In the present disclosure, method 100 is described as being executed by a hosting provider, but in other implementations, method 100 may be performed by another computer system or combination of computer systems configured to perform the method.

In step 102, a request to create a security certificate for a web site (e.g., web site 14) is received. The request may be received from any appropriate requester, such as an owner or administrator for the web site, or the subscriber associated with the web site, and may identify the web site, or a subscriber associated with the web site. The request may be initiated, for example, by the requester logging into a management service for the web site 14 and initiating a process to enable SSL services for the website.

In response to the request for a security certificate, in step 104, the requester is prompted to provide certain information that is required to generate the security certificate, including an identification of the applicant and a copy of the public key that will be signed to create the certificate. In some cases, the requester is prompted to provide the necessary information to construct a CSR for the requester. Alternatively, the requester may simply be prompted to provide a CSR.

Alternatively, rather than require the requester to provide all information necessary to generate the security certificate, some of the information can be retrieved from records stored in various accessible databases. For example, the requester may only be required to provide a minimum amount of information necessary to identify the applicant for the security certificate. Then, based upon the identity of the applicant, information describing the certificate applicant can be retrieved from one or more databases. For example, if the applicant is a customer of hosting provider 16, hosting provider 16 may consult its own customer records database 50 for information describing the applicant.

In step 106, the information provided by the requester and/or retrieved from other records accessible to hosting provider 16 is analyzed to determine whether personal information of the applicant would be included within the certificate. For example, if the applicant is an individual or the principal of a company, then the certificate will include personal information of the certificate applicant (e.g., that individual's name, city of residence, and the like). Conversely, if the applicant is a company, the certificate will instead include identification information for the company, and no personal information of an individual.

In one implementation, the following rule set may be used to determine whether, based upon applicant and/or web site information, and the like, a security certificate issued for the web site will include personal information of an individual:

If it is determined that the certificate would otherwise include personal information of an individual, in step 108 the requester is warned that personal information of an individual may be incorporated into the certificate and prompted to notify the system of whether that personal information should be hidden in the certificate, once created. At this time, the system may provide the requester with a listing of the different types of personal information that may be included within a certificate (e.g., holder's name, city, state, country, and the like). The requester can then indicate for which of those types of information the personal information should not be included in the certificate. The prompt may be in the form of any suitable user interface device for collecting information from the requester, such as a button, checkbox, or other device on a web page, a telephone prompt, and the like. In some cases, the requester may be prompted to provide substitute information that may be used to replace the personal information that would otherwise be included in the certificate.

In various implementations, steps 102, 104, 106, and 108 may be executed in a different order from that depicted in FIG. 3, or the steps may be performed substantially simultaneously. For example, when the requester initiates the process of requesting a security certificate in step 102, the requester can be asked at that time whether the requester wishes to incorporate personal information of an individual into the security certificate (before any analysis of the information provided by the requester is performed). Alternatively, the determination of whether to incorporate personal information in the certificate may be made based upon a particular class of web site security product selected by the requester in conjunction with step 102. For example, different types or classes of security certificates may be offered, where some types of security certificates always include personal information and other classes never include personal information. As such, a security certificate that excludes personal information may be offered as a new type of security product to consumers. In that case, the requester is not prompted for whether personal information should be included in certificate—instead that determination is made implicitly by the type of security certificate requested by the requester.

Alternatively, the form used to collect information from the requester as part of step 104 may include a checkbox where the requester can indicate whether the security certificate should include personal information of an individual. In some cases, the checkbox option may be provided dynamically. In that case, as the requester completes the form, if the requester completes the form by entering applicant information describing a company, the checkbox option is not provided or displayed (as personal information for an individual will not be included in the certificate), however, if the requester completes the form for an individual, the checkbox option appears on the form at the time the requester begins to enter the individual's information. In that case, steps 102, 104, 106, and 108 are being performed together.

Alternatively, rather than prompt the requester to decide whether the personal information should be hidden in the certificate, the system may be configured to automatically hide personal information and never include such information in the contents of a security certificate.

In step 110, the system creates a certificate for the web site. If the requester indicated in response to step 108 that personal information of an individual may be included in the certificate, in step 110 the system creates a certificate for the web site (including, for example, a public security key and a private security key) that includes the personal information.

If, however, the requester indicated in response to step 108 that personal information of an individual should not be included in the certificate, in step 110 the system creates a certificate for the web site that does not include the personal information. When creating the security certificate, the subject information in the certificate is then left blank, or replaced with a string that does not include the personal information identified in step 106. For example, the subject field, may state only ‘PRIVATE’, ‘NOT AVAILABLE’ or another similar message. Alternatively, the personal information may be replaced by other information associated with the web site that is not personal information of an individual. For example, the contents of the subject field may only include information selected from the WHOIS records for the web site, such as information relating to the administrative contact or technical contact for the web site, and the like.

In the event that the WHOIS records for the web site have been made private, the subject information in the security certificate may include the same contact information associated with the private WHOIS records, such as only the identification of a forwarding service associated with the web site.

Alternatively, the subject information in the certificate may identify a proxy entity that, while responsible for receiving communications transmitted to the certificate holder, is able to maintain the confidentiality of the individual that may be the actual holder of the certificate.

In another implementation, the personal information may be replaced with a link or reference to a secondary web site. Once activated, the secondary web site displays a challenge-response test that should be completed before the personal information can be displayed. Example challenge-response tests include CAPTCHAs, picture-based CAPTCHAs, audio CAPTCHAs, and the like. If the challenge-response is completed, the secondary web site may then display the requested personal information. This procedure, although allowing the certificate holder's personal information to be ultimately viewed, prevents that information from being retrieved as part of an automated process to harvest such information.

After generating the security certificate, the system can create a record in certificate database 52 that identifies the certificate (e.g., using the certificate's serial number, or other identifying information) and contains additional information describing the certificate (such as the information included in Table 1, above). In some cases, the entire contents of the security certificate may also be stored within certificate database 52. In addition to storing information describing the certificate, information describing the entity to whom the certificate has been issued (or is going to be issued) can also be stored in certificate database 52.

By storing this information in certificate database 52 (or some other combination of suitable data stores) it is possible for the system, such as hosting provider 16, to retrieve the personal information describing the entity to whom a particular security certificate has been issued, even though that information has not been included in a particular certificate. As such, using only the certificate's ID, certificate database 52 may be utilized to retrieve the personal information of the certificate holder. Certificate database 52 can, therefore, be utilized to identify the certificate holder, should that certificate holder need to be contacted. For example, in the case that there is an allegation of impropriety associated with the certificate, certificate database 52 can be used to identify the certificate holder. A complaint associated with the certificate can then be forwarded to the holder.

As part of creating the certificate in step 110, the information provided in the request (which may include personal information) is analyzed in an attempt to verify the identity of the applicant for the certificate. If able to verify that identify, the requester's certificate (which does not include personal information) will be signed and then can be installed onto the requester's web site and used to verify the authenticity of that web site and to facilitate the execution of secured transactions through that web site. Once installed, customers and/or users of the web site can retrieve the certificate from the web site, use the certificate as part of an encryption regime to protect communications with the web site, and inspect the contents of the certificate. In step 112, the certificate is returned to the requester.

If in step 106, however, it was determined that no personal information would be included within the security certificate (e.g., because the applicant was a company), in step 114 a conventional process is used to create a security certificate that certificate. As part of that process, an attempt is made to verify the identity of the applicant. In some circumstances, as described above, it can be difficult to verify the identity of a company (e.g., if the company is foreign, or not formally organized). In that case, the certificate may be issued to a principal of the company, rather than the company itself, meaning that the certificate may include personal information for that principal. As such, the method returns to step 104, where information describing that principal can be collected for purposes of issuing the certificate. The requester will then be given an option to exclude the principal's personal information from the security certificate, pursuant to the method described above.

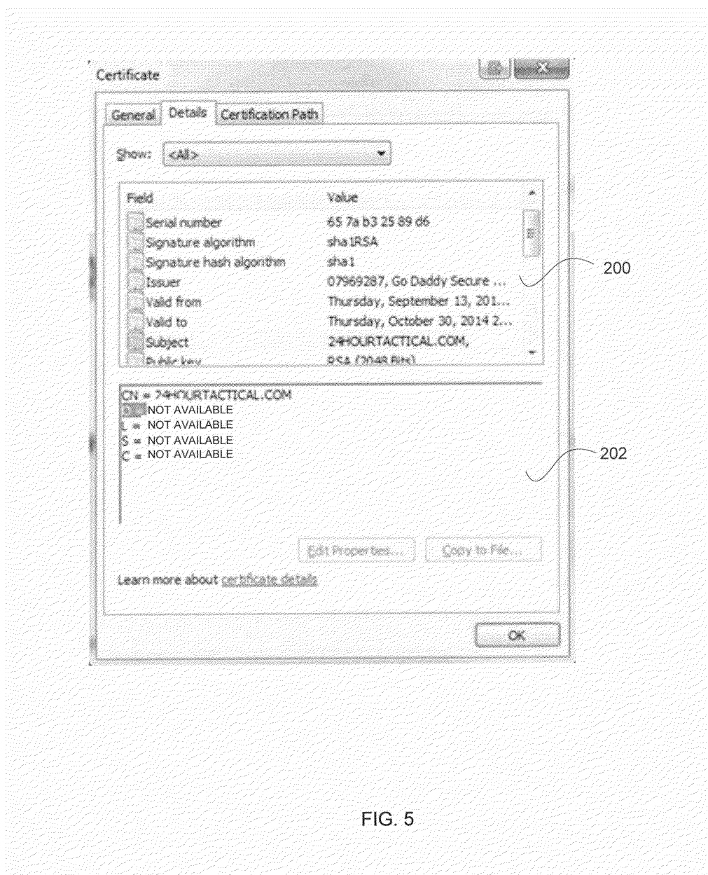

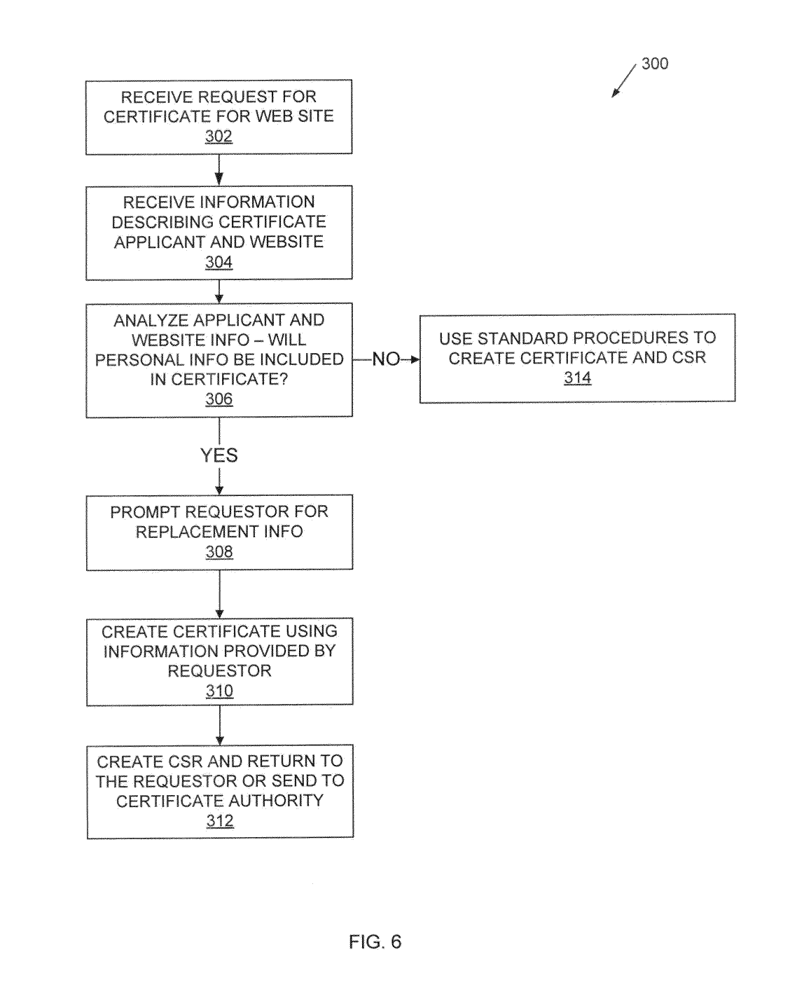

FIG. 5 is an illustration of an exemplary user interface of a program configured to inspect the contents of a security certificate created in accordance with the present disclosure. The interface depicted in FIG. 5 includes a first display area 200 that lists the different fields of information that are included within each certificate. Example fields include the serial number of the certificate, validity dates, the issuer, and the like.

The user can select one of the fields from display area 200, causing the data associated with that particular field to be depicted in the second display area 202. In the example shown in FIG. 5, the user has selected the “Subject” field for a particular certificate. As such, the data making up the subject of the certificate is displayed in display area 202.

In this example, the certificate has been issued to an individual. As such, the individual's personal information has not been included in the subject field of the certificate. Instead, what would have been the individual's person information has been replaced by the text string “NOT AVAILABLE.”

Even though the certificate holder's person information is not available, an individual reviewing the contents of the certificate can still select the “Issuer” field in the display area 200. When selected, the certificate authority associated with the certificate will be displayed in display area 202. This allows the viewer to ensure that the certificate has been issued by a trustworthy certificate authority.

In this manner, even though the personal information of the certificate holder has not been included in the certificate (thereby protecting the privacy of the certificate holder), a user can still access the contents of a security certificate to ensure that the certificate was issued by a trustworthy certificate authority and, thereby, trust the certificate.

As a non-limiting example, the steps described above (and all methods described herein) may be performed by any central processing unit (CPU) or processor in any computer or computing system, such as a microprocessor running on a server computer, and executing instructions stored (perhaps as applications, scripts, apps, and/or other software) in computer-readable media accessible to the CPU or processor, such as a hard disk drive on a server computer, which may be communicatively coupled to a network (including the Internet). Such software may include server-side software, client-side software, browser-implemented software (e.g., a browser plugin), and other software configurations.

This present disclosure describes preferred embodiments with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention has been described in terms of one or more preferred embodiments, and it should be appreciated that many equivalents, alternatives, variations, and modifications, aside from those expressly stated, are possible and within the scope of the invention.

1. A method of creating a security certificate, comprising:
receiving, from a requester, a request for a security certificate, the request including an identification of a web site or an entity associated with the web site;
identifying an applicant for the security certificate using the request;
retrieving information about the applicant for the security certificate, the information about the applicant including a name of the applicant;
analyzing the information about the applicant to determine whether the information about the applicant includes personal information of an individual; and
when the information about the applicant includes personal information of an individual, generating the security certificate, wherein the security certificate does not include the personal information of an individual.

2. The method of claim 1, wherein analyzing the information about the applicant includes determining whether the applicant is an individual or determining that the applicant is not a corporate entity.

3. The method of claim 2, wherein analyzing the information about the applicant includes determining whether the applicant is a corporate entity formed in a foreign country.

4. The method of claim 3, wherein analyzing the information about the applicant includes determining whether the applicant is an unformed corporate entity.

5. The method of claim 1, wherein at least a portion of the information about the applicant is retrieved from a customer database.

6. The method of claim 1, wherein at least a portion of the information about the applicant is retrieved from the requester.

7. The method of claim 1, wherein the requester is the owner or agent of the web site.

8. The method of claim 1, including, when the information about the applicant includes personal information of an individual, prompting the requester to provide replacement information for the personal information of the individual.

9. The method of claim 8, including:
receiving the replacement information about the applicant from the requester; and
including the replacement information about the applicant in the certificate.

10. The method of claim 1, including, when the information about the applicant includes personal information of an individual:
retrieving at least a portion of WHOIS data for the web site; and
including the at least a portion of WHOIS data for the web site in the security certificate.

11. The method of claim 10, wherein the at least a portion of WHOIS data identifies a forwarding service associated with the web site.

12. A method of requesting a security certificate, including:
transmitting a request for a security certificate to a server computer, the request including an identification of a web site or an entity associated with the web site, the request being associated with an applicant for the security certificate, the applicant being an individual;
indicating, to the server computer, that the security certificate is not to include personal information of an individual; and
receiving, from the server computer, a security certificate, wherein the security certificate does not include the personal information of the individual.

13. The method of claim 12, including transmitting, to the server computer, information identifying the applicant for the security certificate.

14. The method of claim 12, including receiving, from the server computer, a warning that the security certificate may include personal information of an individual.

15. The method of claim 12, including transmitting, to the server computer, a replacement string for the personal information of an individual.

16. A security certificate prepared by the steps of:
receiving, from a requester, a request for a security certificate, the request including an identification of a web site or an entity associated with the web site;
retrieving information about an applicant for the security certificate;
analyzing the information about the applicant to determine whether the information about the applicant includes personal information of an individual; and
when the information about the applicant includes personal information of an individual, generating a security certificate, wherein the security certificate does not include the personal information of an individual.

17. The security certificate of claim 16, wherein at least a portion of the information about the applicant is retrieved from a customer database.

18. The security certificate of claim 16, wherein at least a portion of the information about the applicant is retrieved from the requester.

19. The security certificate of claim 16, wherein the requester is the owner or agent of the web site.

20. The security certificate of claim 16, wherein analyzing the information about the applicant includes determining whether the applicant is an individual or determining that the applicant is not a corporate entity.
